(19) United States
(12) Patent Application Publication
(10) Pub. No.: US 2017/0171188 A1
(43) Pub. Date: Jun. 15, 2017

(54) NON-TRANSITORY COMPUTER-READABLE RECORDING MEDIUM, ACCESS MONITORING METHOD, AND ACCESS MONITORING APPARATUS

(71) Applicant: FUJITSU LIMITED, Kawasaki-shi (JP)

(72) Inventors: Masataka Saito, Ota (JP); Shintaro Ishikawa, Kawasaki (JP)

(73) Assignee: FUJllTSU LIM ITED, Kawasaki-shi (JP)

(21) Appl. No.: 15/342,591

(22) Filed: Nov. 3, 2016

(30) Foreign Application Priority Data
Dec. 10, 2015 (JP) 2015-241570

(51) Int. Cl. H04L 29/06

(52) U.S. Cl. CPC H04L 63/083; H04L 63/10; H04L 67/42

(57) ABSTRACT

A non-transitory computer-readable recording medium having stored therein an access monitoring program that causes a computer to execute a process, the process includes detecting, when authentication with identification information and a password of an account of a predetermined access source has failed, unauthorized access in accordance with whether both the identification information and the password have been changed for next authentication of the access source.

### CROSS-REFERENCE TO RELATED APPLICATION

This application is based upon and claims the benefit of priority of the prior Japanese Patent Application No. 2015-241570, filed on Dec. 10, 2015, the entire contents of which are incorporated herein by reference.

### FIELD

The embodiments discussed herein are related to a non-transitory computer-readable recording medium, an access monitoring method, and an access monitoring apparatus.

### BACKGROUND

Clients log in to a server when using a service provided by the server. In recent years, unauthorized third persons have accessed and logged in to servers. Various measures have been taken against such unauthorized access.

In a proposed relevant art, an access log is analyzed to obtain a corresponding illicitness level for each of a plurality of viewpoints, and unauthorized access is detected in accordance with the illicitness level obtained for each of the viewpoints (see, for example, patent document 1).

Patent Document 1: Japanese Laid-open Patent Publication No. 2013-218640

### SUMMARY

According to an aspect of the embodiments, a non-transitory computer-readable recording medium having stored therein an access monitoring program that causes a computer to execute a process, the process includes detecting, when authentication with identification information and a password of an account of a predetermined access source has failed, unauthorized access in accordance with whether both the identification information and the password have been changed for next authentication of the access source.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary overall configuration of a system in accordance with an embodiment;

FIG. 2 is a functional block diagram illustrating an exemplary server;

FIG. 3 illustrates an exemplary login screen;

FIG. 4 illustrates an exemplary access log;

FIG. 5 illustrates an exemplary score table;

FIG. 6 illustrates examples of latest data and an aggregation table;

FIG. 7 illustrates an example of report information;

FIG. 8 illustrates an exemplary graph for a score statistic for identifying an attack time slot;

FIG. 9 is a flowchart illustrating an exemplary flow of an authenticating process;

FIG. 10 is a flowchart illustrating an exemplary flow of an unauthorized access detecting process;

FIG. 11 is a flowchart illustrating an exemplary flow of an option process;

FIG. 12 is a flowchart illustrating an exemplary flow of an attack-time-slot identifying process; and

FIG. 13 illustrates an exemplary hardware configuration of a server.

### DESCRIPTION OF EMBODIMENTS

Authentication is conducted when a client logs in to a server. For example, an Identification (ID) and a password are used for the authentication. When, for example, a set of the ID and the password has been leaked to an unauthorized third person, this person can gain unauthorized access. In this case, it is difficult to detect the unauthorized access.

<An Exemplary System in Accordance with an Embodiment>

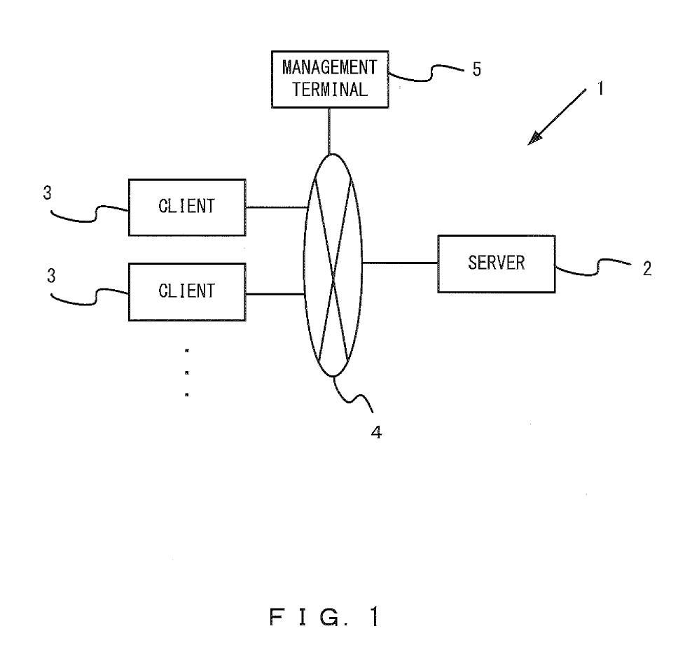

The following describes embodiments with reference to drawings. FIG. 1 illustrates an exemplary overall configuration of a system in accordance with an embodiment. In a system 1 in the example of FIG. 1, a plurality of clients 3 are connected to a server 2 over a network 4. A management terminal 5 is connected to the network 4.

The server 2 is a computer communicably connected to the clients 3 over the network 4. The server 2 is an exemplary access monitoring apparatus. The server 2 provides a predetermined service to the clients 3.

The client 3 is a terminal operated by an operator (hereinafter referred to as a user), and accesses the server 2 according to a user operation. The user uses the service provided by the server 2 by operating the client 3.

The network 4 is an arbitrary network, e.g., the Internet network. The management terminal 5 is a terminal to allow an operator of the management terminal 5 (hereinafter referred to as a manager) to manage the server 2.

The example of FIG. 1 depicts one server 2, but a plurality of servers 2 may be connected to the network 4. The plurality of servers 2 may provide different services to the individual clients 3.

In using a service (function) provided by the server 2, the client 3 logs in to the server 2. The user inputs predetermined information for login to the client 3. Upon the accepting of the input information, the client 3 attempts to log in to the server 2.

To log in to the server 2, the client 3 transmits an authentication request to the server 2. According to the authentication request, the server 2 conducts authentication as to whether the accessing client 3 is a terminal operated by an authorized user.

In an embodiment, the server 2 conducts the authentication using identification information (ID) of, and a password for, an account assigned to the user. Each user is assigned an ID and a password. The server 2 conducts authentication according to whether an ID and password transmitted from the client 3 are authentic.

The server 2 stores an authentic ID and password for each user. In a login operation, authentication succeeds only when both the ID and password transmitted from the client 3 match an authentic ID and password stored in the server 2. Authentication fails when only one of or neither the ID or the password matches the authentic ID or password.

When authentication has succeeded, the client 3 can log in to the server 2, and the server 2 allows the client 3 to gain access. When authentication has failed, the server 2 blocks access from the client 3.

A third person who is not authorized to use the server 2 may access the server 2 using a terminal, and the terminal used by the third person may successfully log in to the server 2.

In this case, the terminal operated by the unauthorized third person may illicitly obtain information stored in the server 2. One manner of such unauthorized accesses is called a password list attack.

A password list attack is, for example, unauthorized access that relies on a list of sets of IDs and passwords leaked from another server 2 (password list).

When, for example, an authorized user uses services provided by a plurality of servers 2 and uses the same ID and password for logins to the servers, it is highly likely that unauthorized access based on a password list attack will succeed.

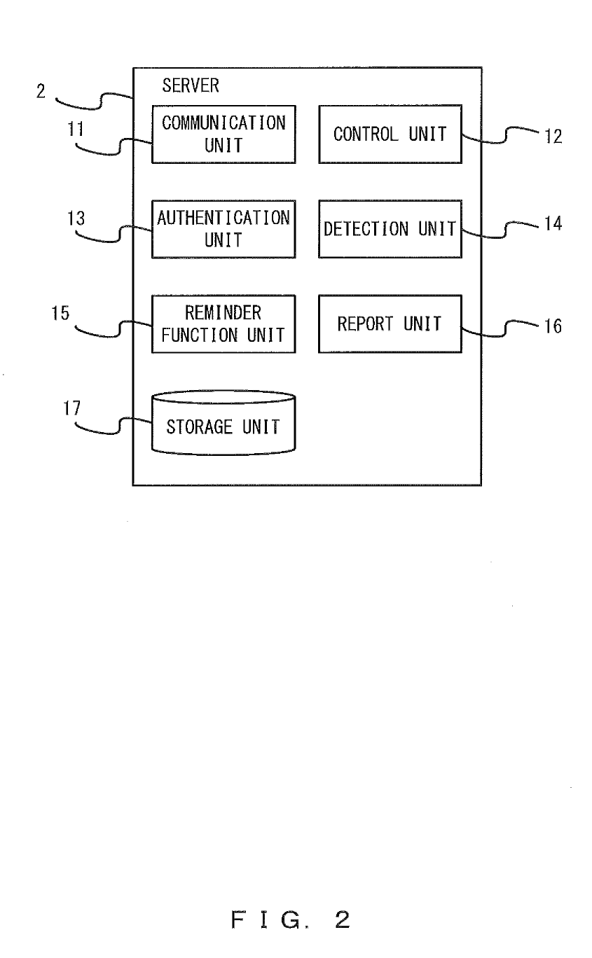

In an embodiment, the server 2 detects unauthorized accesses based on the password list attack with illicitly obtained IDs and passwords. The following describes an example of the server 2 by referring to FIG. 2.

<An Exemplary Server in Accordance with an Embodiment>

As illustrated in the example of FIG. 2, a server 2 includes a communication unit 11, a control unit 12, an authentication unit 13, a detection unit 14, a reminder function unit 15, a report unit 16, and a storage unit 17. The communication unit 11 communicates with clients 3 over the network 4.

The control unit 12 performs various types of controls of the server 2. According to whether an ID and password included in an authentication request received from a client are authentic, the authentication unit 13 conducts authentication for the authentication request.

The storage unit 17 of the server 2 stores sets of authentic IDs and passwords. The authentication unit 13 compares an ID and password included in an authentication request with IDs and passwords stored in the storage unit 17.

Only when both the ID and password included in the authentication request match an ID and password stored in the storage unit 17 does the authentication conducted by the authentication unit 13 succeed. When both the ID and password included in the authentication request, or one of them, match none of the IDs and passwords stored in the storage unit 17, the authentication conducted by the authentication unit 13 fails. When the authentication succeeds, the client 3 can log in to the server 2; when the authentication fails, the server 2 blocks the login from the client 3.

The detection unit 14 detects unauthorized access. The detection unit 14 receives an authentication request again from the same access source within a predetermined time period after the failure of the authentication, and detects unauthorized access according to whether both the ID and password included in the authentication request were changed.

When, for example, the user has forgotten one of or both of the ID and password for the account, the reminder function unit 15 performs a control of reporting the authentic ID and password to the client 3 operated by the user.

When, for example, a user operates the client 3 so as to use a service provided by the server 2 for the first time, the user inputs reminder information to the client 3 in addition to an ID and a password. Reminder information is information for conducting alternative authentication, and is also information that is different from an ID and a password.

The client 3 accepts the inputting of information that includes an ID, a password, and reminder information, and transmits the input information to the server 2. The server 2 stores in the storage unit 17 the various types of information that have been received.

When the server 2 has received a request to allow use of the reminder function, the reminder function unit 15 transmits to the client 3 a request to input reminder information. When the server 2 has received reminder information from the client 3, the authentication unit 13 conducts authentication of the reminder information (alternative authentication).

When the received reminder information matches authentic reminder information stored in the storage unit 17, the reminder function unit 15 performs a control of transmitting an authentic ID and password to the client 3.

When the detection unit 14 has detected unauthorized access, the report unit 16 performs a control of reporting the detection of unauthorized access to the management terminal 5. The storage unit 17 stores various pieces of information.

### <Exemplary Login Screen>

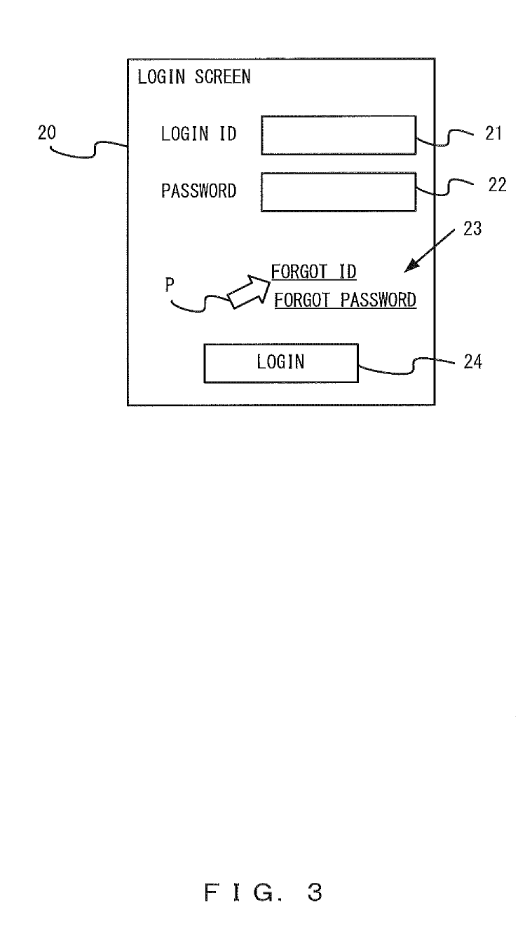

The following describes an exemplary login screen by referring to the example of FIG. 3. A login screen is displayed when the client 3 logs in to the server 2.

A login screen 20 in the example of FIG. 3 includes an ID input field 21, a password input field 22, and a reminder function selection portion 23, and a login button 24. The ID input field 21 is a field for accepting the inputting of an ID. The password input field 22 is a field for accepting the inputting of a password.

For example, the user may use a keyboard or the like so as to input an ID to the ID input field 21 and to input a password to the password input field 22. The client 3 accepts these inputs.

The reminder function selection portion 23 is used when using the reminder function. In the example of FIG. 3, the reminder function selection portion 23 can be selected by a mouse pointer P. For example, the user operates the mouse pointer P using a mouse.

When the client 3 has accepted a press operation performed on the reminder function selection portion 23 using the mouse pointer P, the client 3 transmits to the server 2 a request to allow use of the reminder function.

The login button 24 is a button for logging in to the server 2. When the client 3 has received a press operation performed on the login button 24 by the user, the client 3 transmits to the server 2 an authentication request that includes an input ID and password.

### <Exemplary Access Log>

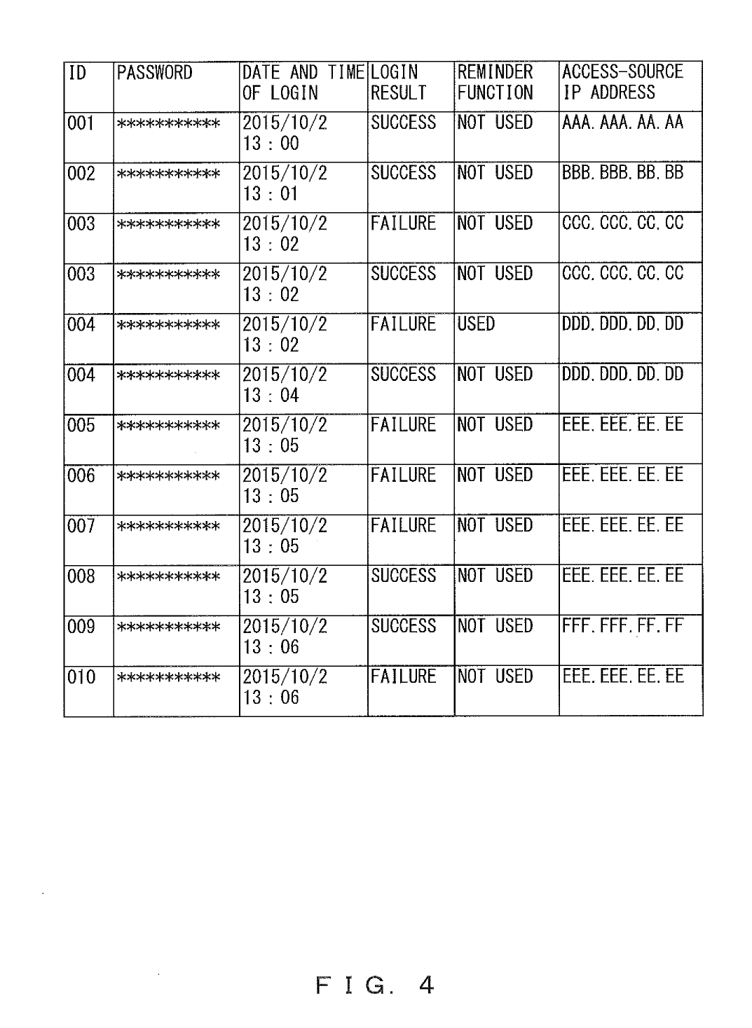

The following describes an exemplary access log by referring to the example of FIG. 4. An access log is information on access associated with login to the server 2, and is stored in the storage unit 17. Every time the server 2 is logged in to, the server 2 adds log items related to login (log related to one access) to the access log.

The access log in the example of FIG. 4 includes items of ID, password, date and time of login, login result, reminder function, and access-source IP address. IP means Internet Protocol.

A login result indicates a success or failure of authentication based on a login operation. A login result indicating success means that authentication succeeded. A login result indicating failure means that authentication failed.

As described above, authentication is conducted according to whether an authentic account ID and password stored in the storage unit 17 match an ID and password included in an authentication request.

As described above, authentication succeeds when both an ID and password included in an authentication request match an authentic account ID and password stored in the storage unit 17. In such a case, the login result of the access log indicates success.

Authentication fails when only one of the ID and password included in an authentication request, or neither of them, matches an authentic account ID and password stored in the storage unit 17. In such cases, the login result of the access log indicates failure.

The item of reminder function indicates for each access whether the reminder function was used. An access-source IP address indicates the IP address of an access-source client 3. An access-source IP address is information for identification of an access-source client 3. As long as an access source can be identified, information that is different from an IP address may be used.

Referring to the access log in the example of FIG. 4, access-source IP address “CCC.CCC.CC.CC” indicates that two authentication requests were successively made. The same ID is assigned to the two authentication requests.

The access log indicates that authentication succeeded for the second authentication request as a result of inputting a correct password. In this case, it is assumed that the password input for the first login operation by an authentic user was incorrect and that a correct password was then input.

In this case, the authentication request from access-source IP address “CCC.CCC.CC.CC” is highly likely to be one based on operations performed by an authentic user.

The access-source IP address “DDD.DDD.DD.DD” in the access login the example of FIG. 4 indicates that the reminder function was used. A user who uses the reminder function is highly likely to be authentic.

The access log in the example of FIG. 4 indicates that different IDs were used for authentication requests from access-source IP address “EEE.EEE.EE.EE”. Assume that a password corresponding to ID “007” and a password corresponding to ID “008” are different.

In a login operation performed by an authentic user, when the first authentication fails, the user is highly likely to change either the input ID or password in a re-login operation but is not likely to change both of them.

That is, access is highly likely to be unauthorized when both an ID and a password have been changed for an authentication request from the same access-source IP address (next authentication). In this case, the detection unit 14 detects the unauthorized access.

In the example of FIG. 4, authentication requests from the access-source IP address “EEE.EEE.EE.EE” in the access log indicate failure as the login result of ID “007” and success as the login result of ID “008”. In this case, it is highly likely that the attack on the server 2 by the unauthorized access was successful.

### <Exemplary Score Table>

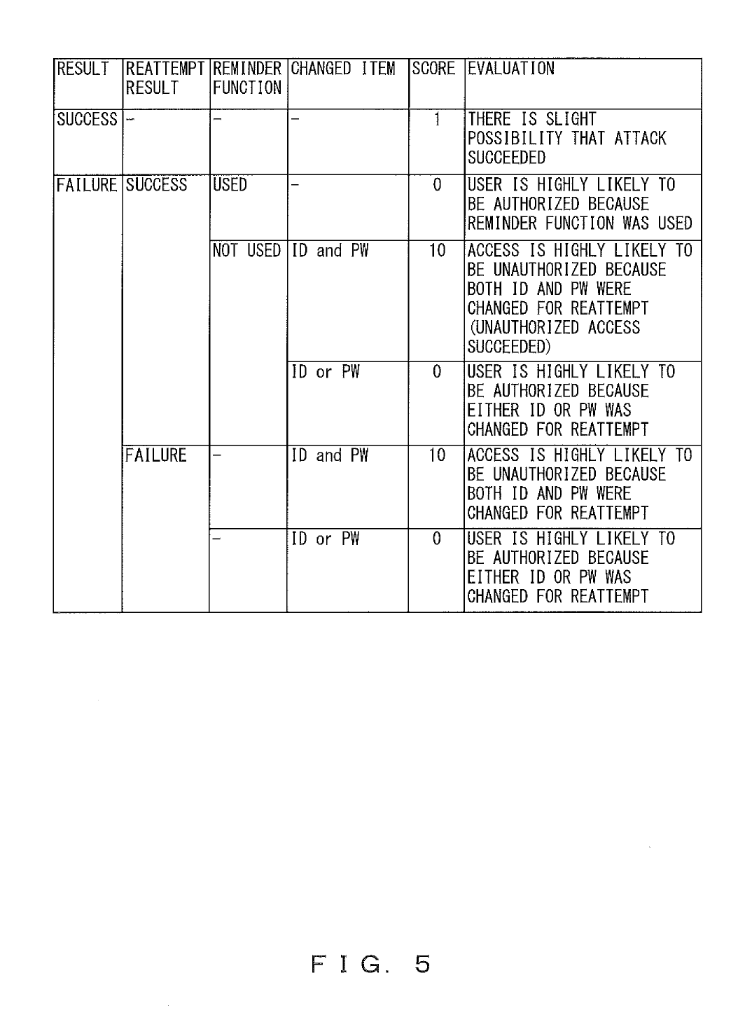

FIG. 5 illustrates an exemplary score table. The storage unit 17 stores a score table. The score table indicates references for the detection unit 14 to assign a score (grade) to each access (each log item) of an access log. Note that FIG. 5 and the following figures may indicate “PW” as a password.

The score table includes result, reattempt result, reminder function, changed item, score, and evaluation. A result indicates the result of authentication conducted by the authentication unit 13. A reattempt result indicates an authentication result for a situation in which an attempt is made to gain access based on a certain authentication request from a certain access-source IP address, and another attempt is made to gain access based on the next authentication request for login (re-login) again from that access-source IP address within a predetermined time period after the certain authentication request has been made.

A changed item indicates which of an ID and a password changed in comparison with a previous authentication request when an authentication request for re-login was made for the server 2. A score indicates an assigned grade. An evaluation describes a score.

A score is a value expressing the likelihood of access being unauthorized. A higher score means a higher likelihood of access being unauthorized, and a lower score means a lower likelihood of access being unauthorized.

When a result indicates success, authentication has a high likelihood of having succeeded as a result of being conducted using an authentic ID and password.

However, in the case of a password list attack, there is the slight possibility that authentication succeeded using an illicitly obtained ID and password (authentication based on unauthorized access). In the example of FIG. 5, the score table indicates “1” as a score when a result indicates success.

When authentication has failed, the reminder function may be used. When the reminder function is used, the authentication request is highly likely to be based on operations performed by an authorized user. In this case, the score table in the example of FIG. 5 indicates “0” as a score.

As described above, when authentication for login has failed, an authorized user would be highly likely to reattempt login by changing an ID or a password.

Hence, in a case where a result is failure and an attempt to log in is made again (in a case where a reattempt result is success or failure), when an ID or a password is changed in making the reattempt to log in, the login is highly likely to be one attempted by an authorized user. In this case, the score table in the example of FIG. 5 indicates “0” as a score.

Meanwhile, in a case where a result is failure and an attempt to log in is made again (in a case where a reattempt result is success or failure), when both an ID and a password are changed in making the reattempt to log in, the access is highly likely to be unauthorized. In this case, the score table in the example of FIG. 5 indicates “10” as a score.

For example, the detection unit 14 may set “2” as a threshold for a score for detecting unauthorized access (hereinafter referred to as a score threshold). The score threshold is an example of the first threshold. When a score based on an access log has exceeded the score threshold, the detection unit 14 may detect unauthorized access.

In this case, unauthorized access is detected when both an ID and a password are changed in making a reattempt to log in. Scores are not limited to those in the example of FIG. 5.

### <Exemplary Latest Data and Aggregation Table>

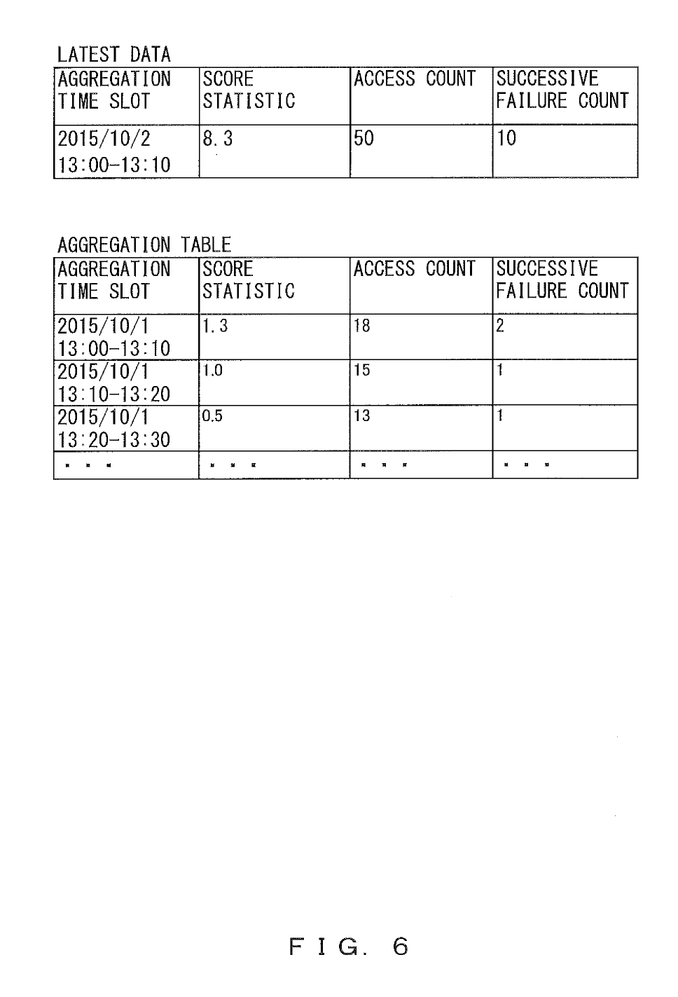

The latest data depicted in the example of FIG. 6 is data on access to the server 2 in a predetermined time slot (indicated as an aggregation time slot in FIG. 6). In the example of FIG. 6, the latest data indicates data on access to the server 2 that occurs in a 10 minute period.

The latest data includes items of score statistic, access count, and successive failure count. In the example of FIG. 6, assume that the current time is “13:11” on “2015/10/2”.

Assume that the latest data is data on access to the server 2 that occurs in the 10 minutes of “2015/10/2 13:00-13:10”. The control unit 12 aggregates log items of access logs included in the 10 minutes. The control unit 12 obtains the score of each access log included in the aggregation time slot of the latest data from the storage unit 17, and performs statistical processing for each of the obtained scores.

In an embodiment, the value obtained by performing statistical processing for each score is the average of the scores. In the example of FIG. 6, the score statistic for the aggregation time slot is “8.3”. The score statistic may be a value that is not an average and that is obtained by performing statistical processing. The score statistic is an exemplary value based on a grade.

The access count indicates the number of accesses (number of log items) that are included in the aggregation time slot. The successive failure count indicates the number of times a request to allow access to the server 2 that is sent from the same access source IP address successively failed, among the access logs included in the aggregation time slot. The control unit 12 obtains an access count and a successive failure count according to access logs.

When the latest data described above has become past data, the control unit 12 adds this latest data to the aggregation table. The data for the 10 minutes of “2015/10/2 13:00-13:10” is past data at, for example, “13:21” on “2015/10/2”. In this case, the control unit 12 adds the latest data to the aggregation table.

In the example of FIG. 6, the score statistic of the latest data is higher than the score statistics for the past aggregation time slots of the aggregation table. Score statistic “8.3” is higher than “2”, the score threshold. Accordingly, it is highly likely that unauthorized access to the server 2 has occurred during the aggregation time slot of the latest data.

The access count and successive failure count of the latest data are far larger than those in the past aggregation time slots. This also indicates that unauthorized access to the server 2 is highly likely to have occurred during the aggregation time slot of the latest data.

### <Exemplary Report to Management Terminal>

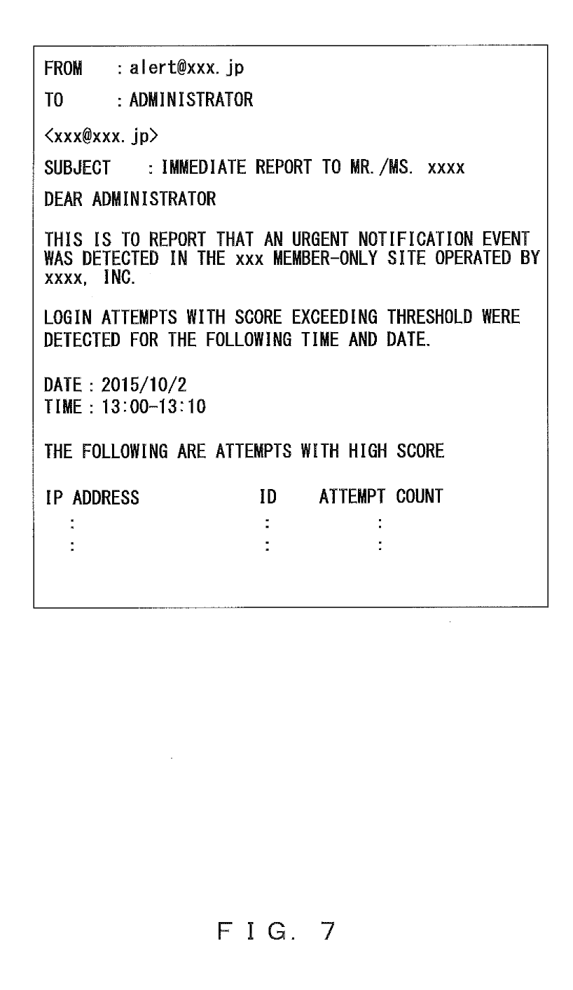

With reference to the example of FIG. 7, the following describes an exemplary report sent to the management terminal 5 when the detection unit 14 has detected unauthorized access. The control unit 12 identifies from within the aggregation table an aggregation time slot with a score statistic exceeding the score threshold.

The control unit 12 extracts, from an access log, accesses with a date and time of login included in the identified aggregation time slot. The control unit 12 assigns a score-table-based score to each of the extracted accesses.

The control unit 12 extracts accesses to which a score greater than the first threshold has been assigned. The extracted accesses are highly likely to be unauthorized.

According to the access log, the control unit 12 identifies, from among the accesses included in the identified aggregation time slot, the same access-source IP addresses as those of the extracted accesses, and also identifies the number of times access from each of the access-source IP addresses occurred. This identified number, i.e., the number of times such access occurs, may hereinafter be referred to as an attempt count.

The control unit 12 provides the report unit 16 with report information that includes the aggregation time slot, the identified access-source IP addresses, and IDs and attempt counts that correspond to the extracted accesses. According to the report information, the report unit 16 reports to the management terminal 5 that unauthorized access has been detected. FIG. 7 depicts an example of report information that the report unit 16 reports to the management terminal 5.

### <Exemplary Identifying of Attack Time Slot>

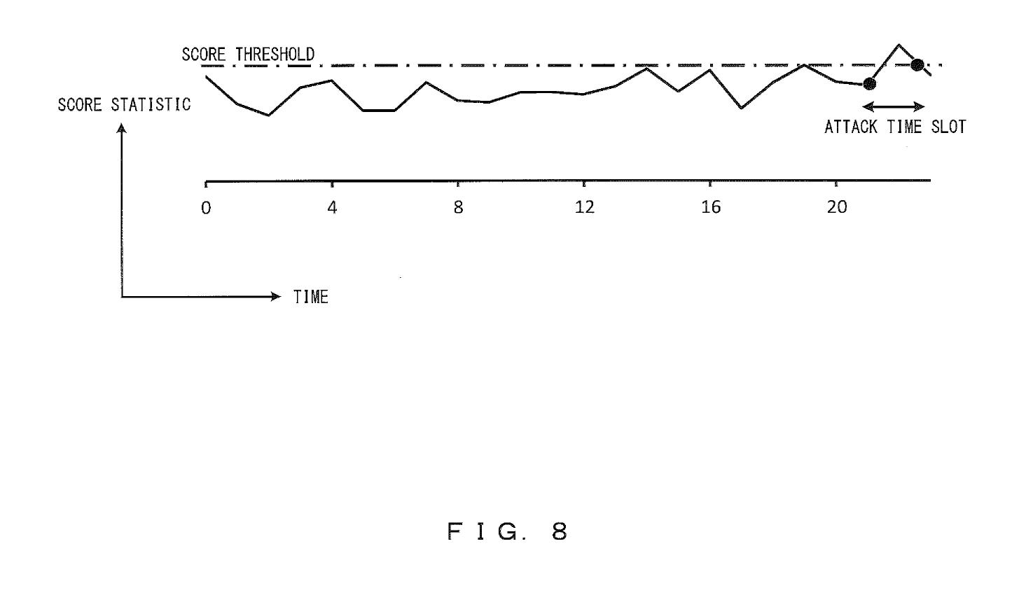

FIG. 8 illustrates an exemplary graph for a score statistic for identifying an attack time slot. In FIG. 8, a time of the day is indicated on the abscissa, and a score statistic is indicated on the ordinate. According to the aggregation table, the control unit 12 graphs the score statistic for the aggregation time slots of the date.

At the moment at which the score statistic has exceeded a score threshold, the detection unit 14 detects unauthorized access. When unauthorized access to the server 2 has occurred, the score statistic successively increases. According to the graphed score statistic, the control unit 12 identifies a time before the detection of unauthorized access by the detection unit 14 at which the value indicated by the graph started to increase (hereinafter referred to as a starting point).

The control unit 12 also identifies a time at which the value indicated by the graph for the score statistic becomes equal to the score threshold or lower (hereinafter referred to as an end point). The circles filled in in black in the example of FIG. 8 represent a starting point and an end point. The control unit 12 identifies the time slot from the starting point to the end point as an attack time slot (time slot in which unauthorized access occurred).

The value indicated by the graph for the score statistic in the identified attack time slot successively increases, exceeds the score threshold, starts to decrease, and then becomes equal to the score threshold or lower. This indicates that unauthorized access to the server 2 is highly likely to have occurred during the attack time slot.

The report unit 16 may incorporate information on the attack time slot into the report information described above. In this case, since the attack time slot is reported to the management terminal 5, the manager of the management terminal 5 can recognize the time slot in which unauthorized access occurred.

### <Exemplary Flowchart Illustrating Process Flow of an Embodiment>

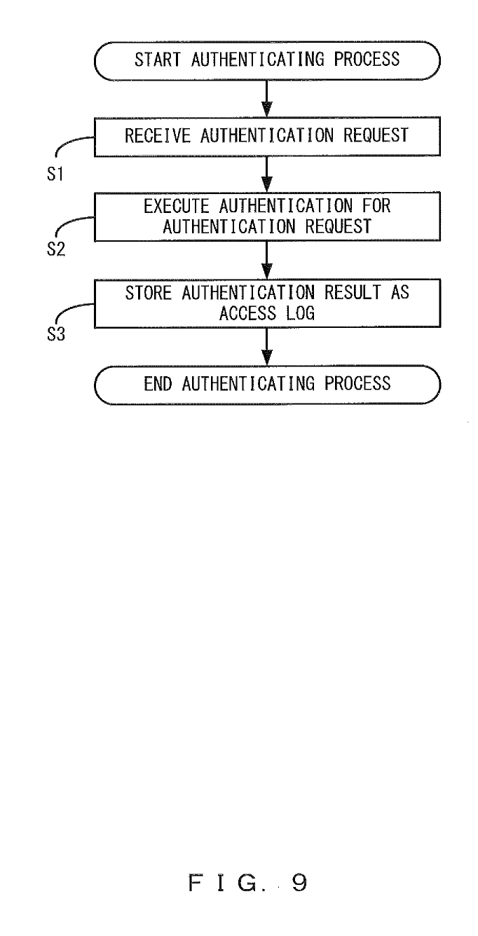

The following describes an exemplary authenticating process with reference to FIG. 9. A client 3 transmits an authentication request for login to the server 2. The communication unit 11 of the server 2 receives the authentication request (step S1).

The authentication unit 13 executes authentication for the received authentication request (step S2). The authentication request includes an ID and password for an account. The authentication unit 13 compares an authentic ID and password stored in the storage unit 17 with the received ID and password.

Authentication succeeds only when both the ID and password included in the authentication request match an authentic account ID and password stored in the storage unit 17. Authentication fails when only one of or neither the ID or password included in the authentication request matches an authentic account ID and password stored in the storage unit 17.

The authentication request includes information on the ID, the password, and an access-source IP address. The authentication request also includes information indicating whether the reminder function has been used.

Together with the various pieces of information described above, the control unit 12 stores in the storage unit a result of the authentication conducted by the authentication unit 13, and also stores, in the storage unit 17 as a date and time of login, a date and time at which the authentication was conducted for the authentication request; the control unit 12 defines these pieces of stored information as access logs (step S3).

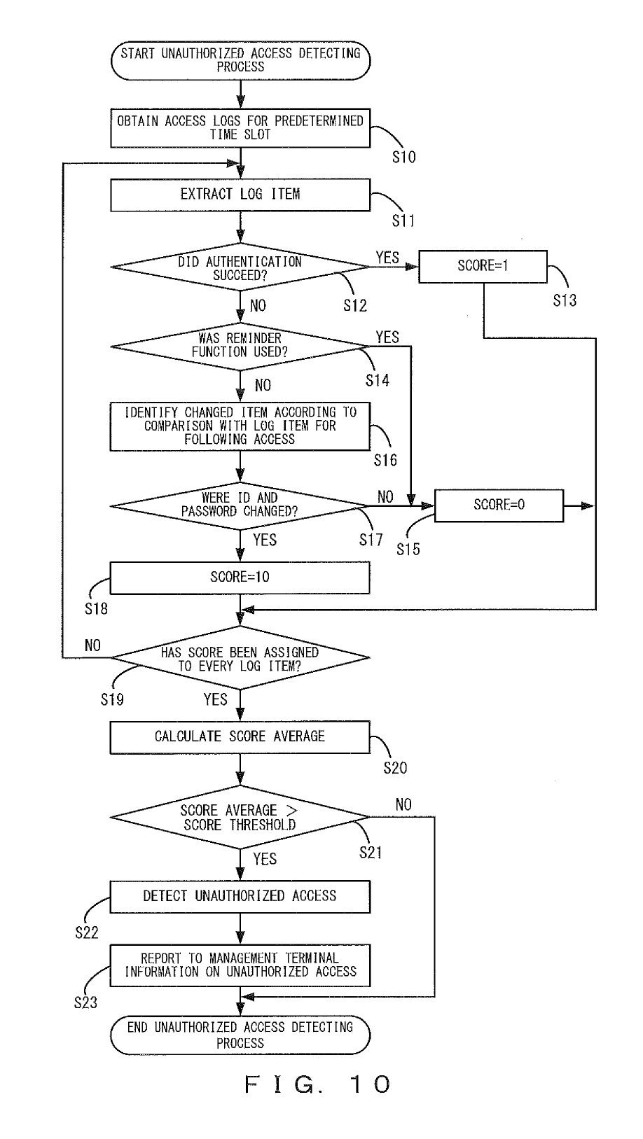

The following describes an unauthorized access detecting process with reference to FIG. 10. The control unit 12 obtains access logs for a predetermined time slot from the access logs stored in the storage unit 17 (step S10).

The obtained access logs include log items each related to an access (log related to one access). The control unit 12 extracts one of the plurality of log items (step S11). For example, the control unit 12 may extract log items according to a temporal order from the access logs obtained in step S10.

The control unit 12 determines whether authentication succeeded by referring to the login results in the extracted log items (step S12). When a log item indicates success of authentication (YES in step S12), the control unit 12 assigns, according to the score table, score “1” to the access corresponding to this log item (step S13).

When a log item indicates failure of authentication (NO in step S12), the control unit 12 determines whether the reminder function was used, by referring to the reminder-function item in this log item (step S14).

When the log item indicates that the reminder function was used (YES in step S14), the control unit 12 assigns, according to the score table, score “0” to the access corresponding to this log item (step S15).

When the log item indicates that the reminder function was not used (NO in step S14), the control unit 12 extracts, from the access logs obtained in step S10, a log item for the access that follows the access corresponding to the log item extracted in step S11.

The control unit 12 compares the extracted log item for the following access with the log item extracted in step S11 so as to identify a changed item (step S16). The changed item indicates that both the ID and the password were changed, or that either the ID or the password was changed, as described above.

The control unit 12 determines whether both the ID and the password were changed (step S17). When the log item indicates that either the ID or the password was changed (NO in step S17), the control unit 12 assigns score “0” to the access corresponding to the log item (step S15).

When the log item indicates that both the ID and the password were changed (YES in step S17), the control unit 12 assigns score “10” to the access corresponding to the log item (step S18).

After the processes of steps S13, S15, and S18 are performed, the detection unit 14 may detect unauthorized access according to the assigned score and the score threshold.

When, for example, an assigned score is “0” or “1”, the detection unit 14 does not detect unauthorized access since the score is lower than the score threshold, “2”. When an assigned score is “10”, the detection unit 14 does detect unauthorized access since the score is higher than the score threshold.

In an embodiment, the detection unit 14 detects unauthorized access according to a score statistic for a predetermined time slot. The control unit 12 determines whether a score has been assigned to every log item included in the access logs obtained in step S10 (step S19).

When a score has not been assigned to every log item, the process returns to step S11. When a score has been assigned to every log item included in the access logs obtained in step S10, the control unit 12 calculates a score average (step S20).

In an embodiment, an average is used for statistics on the score assigned to accesses for each log item for a predetermined time slot. Accordingly, the control unit 12 divides the total of the scores assigned to accesses corresponding to the log items for the predetermined time slot by the number of the log items. This provides the score average.

When the score average is higher than the score threshold (YES in step S21), the detection unit 14 detects unauthorized access (step S22). Meanwhile, when the score average is equal to or lower than the score threshold (NO in step S21), the detection unit 14 does not detect unauthorized access.

When the detection unit 14 has detected unauthorized access, the report unit 16 performs control for transmitting report information related to the detected unauthorized access to the management terminal 5 (step S23). According to the control, the communication unit 11 transmits the report information to the management terminal 5.

For example, it is possible for an authorized user to change both an ID and a password when reattempting to log in. In an embodiment, the detection unit 14 detects unauthorized access according to the average of scores assigned to a plurality of accesses that occur in a predetermined time slot, thereby improving accuracy of unauthorized access detection.

In the unauthorized access detecting process, the following access in step S16 occurs within the predetermined time slot. In step S10, the access logs for the predetermined time slot are obtained; in step S16, the extracted log item is compared with the log item of the following access.

Hence, when the following access in step S16 is not an access that occurred within the predetermined time slot, the comparing in step S16 is not performed. This is because unauthorized accesses from a password list attack would occur successively within a short time period.

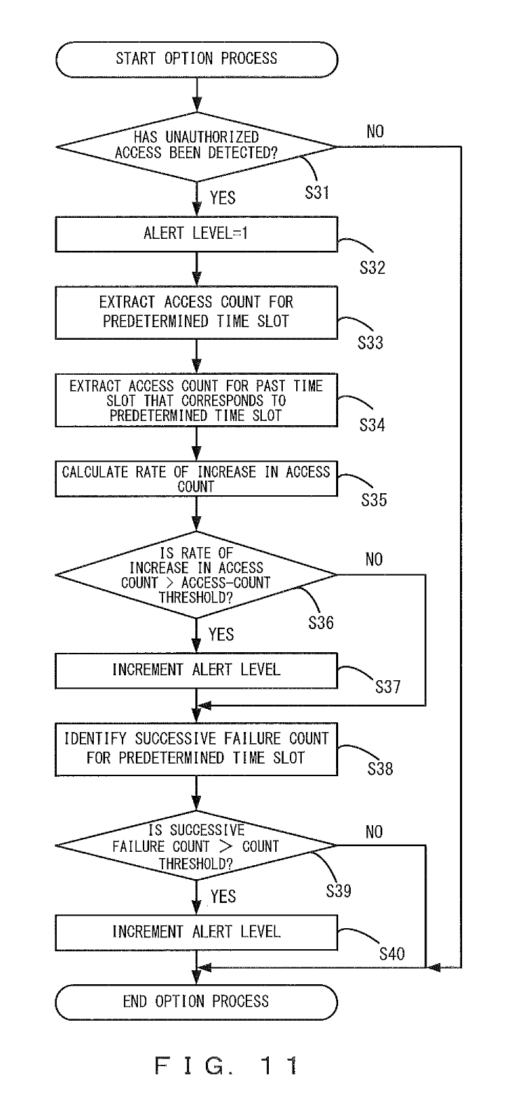

The following describes an option process with reference to FIG. 11. The option process is one for identifying the level of a probability of access being unauthorized. When unauthorized access is detected in the unauthorized access detecting process depicted in the example of FIG. 10, it is possible that the detected unauthorized access is based on a login operation performed by an authorized user.

The option process improves accuracy of unauthorized access detection. The control unit 12 determines whether the detection unit 14 has detected unauthorized access in the unauthorized access detecting process depicted in the example of FIG. 10 (step S31).

When unauthorized access has not been detected (NO in step S31), the option process ends. When unauthorized access has been detected (YES in step S31), the control unit 12 sets “1” as an alert level (step S32).

The alert level indicates the probability of access detected in the unauthorized access detecting process being unauthorized. A higher alert level means that the detected unauthorized access is more likely to actually be unauthorized.

The control unit 12 extracts from an access log an access count for a predetermined time slot (aggregation time slot) (step S33). The control unit 12 also extracts from the access log an access count for a past time slot that corresponds to the predetermined time slot for which an access count has been extracted in step S33 (step S34).

The past time slot that corresponds to the predetermined time slot is, for example, the same time slot one day ago. When, for example, the predetermined time slot is “2015/10/2 13:00-13:10”, the past time slot that corresponds to the predetermined time slot is “2015/10/1 13:00-13:10”.

The control unit 12 divides the access count extracted in step S33 by the access count extracted in step S34 so as to calculate a rate of increase in access count (step S35). The rate of increase in access count indicates the degree of an increase in access count relative to that for the same time slot one day ago.

The same time slot one day before the predetermined time slot is assumed to involve little change in access count for the server 2. Accordingly, a large change (increase) in the rate of increase in access count means that unauthorized access to the server 2 is highly likely to have occurred.

The control unit 12 determines whether the rate of increase in access count is greater than an access-count threshold (step S36). The access-count threshold is used to determine whether to increase the level of the probability of access being unauthorized, and may be an arbitrary value. The access-count threshold is an example of the second threshold.

When the rate of increase in access count is greater than the access-count threshold (YES in step S36), the control unit 12 increments the alert level (step S37). In this case, the alert level becomes “2”. When the rate of increase in access count is equal to or lower than the access-count threshold (NO in step S36), the alert level is not incremented.

According to the access log, the control unit 12 identifies the number of times authentication of access from the same access-source IP address successively failed (successive failure count) (step S38). When authentication of access from the same access-source IP address successively fails within a short time period, the access is highly likely to be unauthorized.

The control unit 12 determines whether the identified successive failure count is greater than a count threshold (step S39). The count threshold is used to determine whether to increase the level of a probability of access being unauthorized, and may be an arbitrary value. The count threshold is an example of the third threshold.

When the identified successive failure count is greater than the count threshold (YES in step S39), the control unit 12 increments the alert level (step S40). When the process of step S37 has been performed, the alert level becomes “3”. When the process of step S37 has not been performed, the alert level is “2”.

When the identified successive failure count is equal to or lower than the count threshold (NO in step S39), the process ends without the control unit 12 incrementing the alert level.

Hence, when the alert level is “3”, the probability of detected unauthorized access actually being unauthorized is the highest. For example, the report unit 16 may perform control for transmitting to the management terminal 5 report information that includes information indicating that the probability of detected unauthorized access being unauthorized is high. In this way, the manager of the management terminal 5 can be informed of the fact that access with a high probability of being unauthorized has been detected.

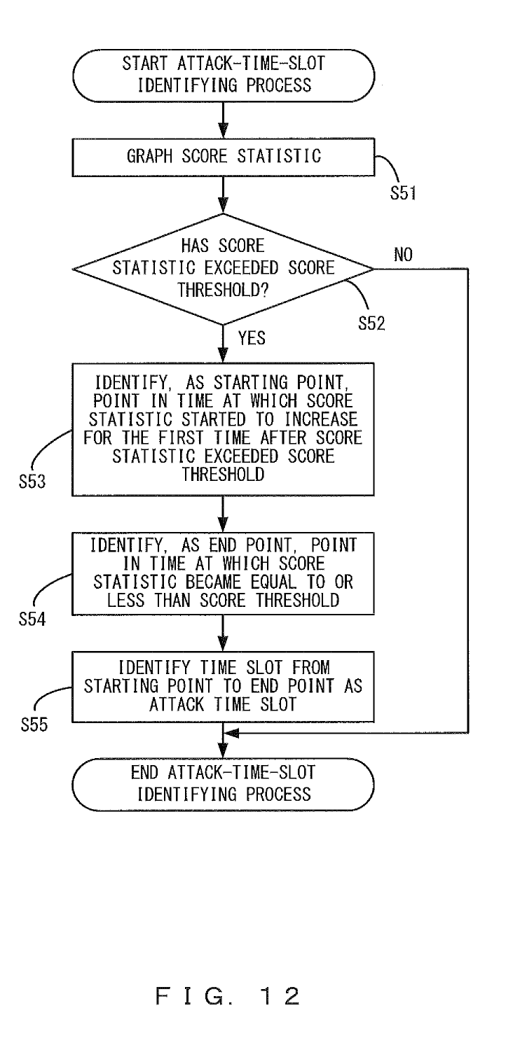

The following describes an exemplary attack-time-slot identifying process with reference to the example of FIG. 12. The control unit 12 graphs a score statistic according to the aggregation table (step S51). The control unit 12 determines whether the score statistic has exceeded the score threshold (step S52).

When the score statistic has not exceeded the score threshold (NO in step S52), the process ends. When the score statistic has exceeded the score threshold (YES in step S52), the control unit 12 identifies a time at which the score statistic exceeded the score threshold.

In the graph, the control unit 12 identifies, as a starting point, a time before the identified time at which the score statistic started to increase (step S53). In the graph, the control unit 12 also identifies, as an end point, a time after the score statistic exceeded the score threshold at which the score statistic became equal to or lower than the score threshold (step S54).

The control unit 12 identifies a time slot from the starting point to the end point as an attack time slot (step S56). Then, the process ends.

### <Exemplary Hardware Configuration of Server>

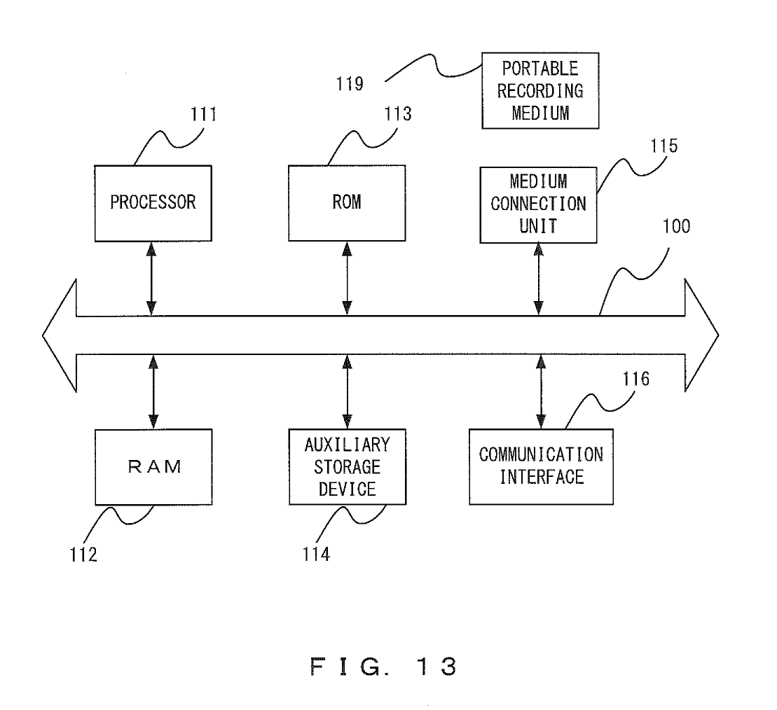

The following describes an exemplary hardware configuration of the server 2 with reference to the example of FIG. 13. As illustrated in the example of FIG. 13, a processor 111, a Random Access Memory (RAM) 112, a Read Only Memory (ROM) 113, an auxiliary storage device 114, a medium connection unit 115, and a communication interface 116 are connected to a bus 100.

The processor 111 is an arbitrary processing circuit. The processor 111 executes a program loaded into the RAM 112. The executed program may be one for performing processing in accordance with each embodiment. The ROM 113 is a nonvolatile storage device that stores a program loaded into the RAM 112.

The auxiliary storage device 114 stores various pieces of information. For example, a hard disk drive or a semiconductor memory may be used as the auxiliary storage device 114. The medium connection unit 115 is connectable to a portable recording medium 119.

The portable recording medium 119 may be a portable memory or an optical disk (e.g., Compact Disc (CD) or Digital Versatile Disc (DVD)). The portable recording medium 119 may have recorded therein a program for performing processing in accordance with each embodiment.

The communication unit 11 of the server 2 may be achieved by the communication interface 116. The storage unit 17 may be achieved by the RAM 112 or the auxiliary storage device 114.

The control unit 12, the authentication unit 13, the detection unit 14, the reminder function unit 15, and the report unit 16 may be achieved by the processor 111 executing a given access monitoring program.

All of the RAM 112, the ROM 113, the auxiliary storage device 114, and the portable recording medium 119 are exemplary computer-readable tangible storage media. These tangible storage media are not transitory media such as signal carrier waves.

### <Other Items>

Unauthorized access may be detected in accordance with each embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an access monitoring program that causes a computer to execute a process comprising:
detecting, when authentication with identification information and a password of an account of a predetermined access source has failed, unauthorized access in accordance with whether both the identification information and the password have been changed for next authentication of the access source.

2. The non-transitory computer-readable recording medium according to claim 1, wherein
the unauthorized access relies on a list of sets of leaked IDs and passwords.

3. The non-transitory computer-readable recording medium according to claim 1, wherein the process further comprises:
detecting, when the next authentication of the access source is conducted within a predetermined time period, the unauthorized access in accordance with whether both the identification information and the password have been changed.

4. The non-transitory computer-readable recording medium according to claim 1, wherein the process further comprises:
refraining from detecting the unauthorized access when a function for reporting the identification information and the password to the access source has been used for alternative authentication in accordance with the failure of the authentication.

5. The non-transitory computer-readable recording medium according to claim 1, wherein the process further comprises:
assigning a grade that is a value expressing a likelihood of access being unauthorized to each of a plurality of access sources according to a result of the authentication and a result changed in the next authentication; and
detecting the unauthorized access when a value based on the grade of each of a plurality of accesses that occurred in a predetermined time slot has exceeded a first threshold.

6. The non-transitory computer-readable recording medium according to claim 5, wherein the process further comprises:
increasing a level of a probability of the detected unauthorized access being unauthorized, when the value based on the score is equal to or greater than the first threshold, and a rate of increase in an access count for a past time slot that corresponds to the predetermined time slot has exceeded a second threshold relative to an access count for the predetermined time slot.

7. The non-transitory computer-readable recording medium according to claim 5, wherein the process further comprises:
increasing a level of a probability of the detected unauthorized access being unauthorized, when the value based on the score is equal to or greater than the first threshold, and a successive failure count for authentication of a same access source conducted in the predetermined time slot has exceeded a third threshold.

8. The non-transitory computer-readable recording medium according to claim 5, wherein the process further comprises:
when the value based on the score increases successively to the first threshold or greater and then decreases to a value lower than the first threshold, identifying, as a time period in which the unauthorized access occurred, a time period from a time at which the value based on the score started to successively increase to a time at which the value based on the score became the value lower than the first threshold after the decreasing.

9. The non-transitory computer-readable recording medium according to claim 1, wherein the process further comprises:
when the unauthorized access has been detected, reporting, to another computer, information that includes information indicating that the unauthorized access has been detected and information on an access source of the unauthorized access.

10. An access monitoring method conducted by a processor, the access monitoring method comprising:
detecting, when authentication with identification information and a password of an account of a predetermined access source has failed, unauthorized access in accordance with whether both the identification information and the password have been changed for next authentication of the access source.

11. An access monitoring apparatus comprising:
a processor configured to execute a process including:
detecting, when authentication with identification information and a password of an account of a predetermined access source has failed, unauthorized access in accordance with whether both the identification information and the password have been changed for next authentication of the access source.
